(19) United States
(12) Patent Application Publication
(10) Pub. No.: US 2026/0332973 A1
(43) Pub. Date: Oct. 22, 2026

(54) EAR-WEARABLE ELECTRONIC DEVICE HAVING A CONFORMAL COATING

(71) Applicant: Starkey Laboratories, Inc., Eden Prairie, MN (US)

(72) Inventors: Darin Jensen, Savage, MN (US); Kurt Koubal, Minnetonka, MN (US)

(21) Appl. No.: 19/650,519

(22) Filed: Apr. 17, 2026

Related U.S. Application Data
(60) Provisional application No. 63/792,435, filed on Apr. 22, 2025.

(51) Int. Cl. H04R 25/00; H04R 1/1025; H04R 1/28

(52) U.S. Cl. CPC H04R 25/658; H04R 1/1025; H04R 1/2876; H04R 25/602; H04R 25/604; H04R 25/609; H04R 2225/31; H04R 2225/57

(57) ABSTRACT

An ear-wearable electronic device can include a housing having an outer surface and an inner surface that defines an interior volume. The device can include an electronics module disposed at least partially within the interior volume of the housing, where the electronics module includes a frame and a plurality of electronic components connected to the frame, where the components can include a microphone. The device can include a conformal coating disposed on at least 90 percent and no greater than 98 percent of exposed surfaces of the electronics module, where exposed surfaces of the electronics module include exposed surfaces of the frame and each electronic component of the plurality of electronic components connected to the frame. An uncoated portion of the electronics module can include a microphone port of the microphone.

### CROSS-REFERENCE TO RELATED APPLICATIONS

This application claims the benefit of U.S. Provisional Application No. 63/792,435, filed Apr. 22, 2025, the disclosure of which is incorporated by reference herein in its entirety.

### BACKGROUND

Ear-wearable electronic devices such as hearing devices can be disposed in or on an ear of a wearer or inserted into an opening of an ear canal of the wearer and typically include a housing or shell with electronic components such as a receiver (i.e., speaker) disposed within the housing. The receiver is adapted to provide acoustic information in the form of acoustic energy or waves to the wearer’s ear canal from a controller either disposed within the housing of the hearing device or connected to the hearing device by a wired or wireless connection. This acoustic information can include music or speech from a recording or other source, e.g., ambient sounds such as speech from a person or persons that are speaking in proximity to the wearer. Such speech can be amplified so that the wearer can better hear the speaker.

Ear-wearable electronic devices such as hearing aids can be used to assist wearers suffering hearing loss by amplifying sounds into one or both ear canals. Such devices typically include hearing assistance components such as a microphone for receiving ambient sound, an amplifier for amplifying the microphone signal in a manner that depends upon the frequency and amplitude of the microphone signal, a speaker or receiver for converting the amplified microphone signal to sound for the wearer, and a power source such as a battery for powering the components.

### SUMMARY

In general, the present disclosure provides various embodiments of an ear-wearable electronic device that includes a housing and an electronics module disposed at least partially within an interior volume of the housing. A conformal coating is disposed on exposed surfaces of the electronics module, where such exposed surfaces of the module include exposed surfaces of a frame of the module and each electronic component of the module that is connected to the frame. In one or more embodiments, the conformal coating can be disposed on at least 90 percent of these exposed surfaces of the electronics module. Further, in one or more embodiments, the exposed surfaces upon which the coating is disposed can include exposed surfaces of an inner side of the frame that defines an inner volume of the electronics module and exposed surfaces of an electronic component that is disposed within this inner volume. The conformal coating can include any suitable thickness, e.g., at least 5 micrometers. In one or more embodiments, the electronics module can include one or more uncoated portions, e.g., at least one of a microphone port of a microphone of the module or a charging contact that is electrically connected to a power source of the module.

In some aspects, the techniques described herein relate to an ear-wearable electronic device including: a housing including an outer surface and an inner surface that defines an interior volume; an electronics module disposed at least partially within the interior volume of the housing, wherein the electronics module includes: a frame; and a plurality of electronic components connected to the frame and including a microphone; and a conformal coating disposed on at least 90 percent and no greater than 98 percent of exposed surfaces of the electronics module, wherein exposed surfaces of the electronics module include exposed surfaces of the frame and each electronic component of the plurality of electronic components connected to the frame, wherein an uncoated portion of the electronics module includes a microphone port of the microphone.

In some aspects, the techniques described herein relate to an electronics module for an ear-wearable electronic device, the electronics module including: a housing including an outer surface and an inner surface that defines an interior volume; an electronics module disposed at least partially within the interior volume of the housing, wherein the electronics module includes: a frame; and a plurality of electronic components connected to the frame and including a microphone; and a conformal coating disposed on exposed surfaces of the electronics module, wherein the coating is configured to reduce a noise floor of the device compared to a noise floor of the device including the electronics module without the coating.

In some aspects, the techniques described herein relate to a method of forming an ear-wearable electronic device including forming an electronics module, wherein forming the electronics module includes: disposing a plurality of electronic components on a frame, wherein the plurality of electronic components includes a microphone; and disposing a conformal coating on the electronics module so that the coating is disposed on at least 90 percent and no greater than 98 percent of exposed surfaces of the electronics module, wherein the exposed surfaces of the electronics module include exposed surfaces of the frame and each electronic component of the plurality of electronic components connected to the frame, wherein an uncoated portion of the electronics module includes a microphone port of the microphone.

All headings provided herein are for the convenience of the reader and should not be used to limit the meaning of any text that follows the heading, unless so specified.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements. The term “consisting of” means “including,” and is limited to whatever follows the phrase “consisting of.” Thus, the phrase “consisting of” indicates that the listed elements are required or mandatory and that no other elements may be present. The term “consisting essentially of” means including any elements listed after the phrase, and is limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to embodiments of the disclosure that may afford certain benefits, under certain circumstances; however, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

These and other aspects of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 is a schematic perspective view of one embodiment of an ear-wearable electronic device.

FIG. 2 is a schematic cross-section view of a housing and electronics module of the device of FIG. 1.

FIG. 3 is a schematic cross-section view of the housing of the device of FIG. 1 with the electronics module of FIG. 2 of the device removed for explanatory purposes.

FIG. 4 is a schematic perspective view of the electronics module of the device of FIG. 1 including a conformal coating disposed over at least a portion of the module.

FIG. 5 is a schematic cross-section view of the electronics module of FIG. 4.

FIG. 6 is a schematic plan view of another embodiment of an electronics module that can be utilized with the ear-wearable electronic device of FIG. 1.

FIG. 7 is a flowchart of one technique of manufacturing the ear-wearable electronic device of FIG. 1.

FIG. 8 is a schematic diagram of another embodiment of an ear-wearable electronic device.

### DETAILED DESCRIPTION

In general, the present disclosure provides various embodiments of an ear-wearable electronic device that includes a housing and an electronics module disposed at least partially within an interior volume of the housing. A conformal coating is disposed on exposed surfaces of the electronics module, where such exposed surfaces of the module include exposed surfaces of a frame of the module and each electronic component of the module that is connected to the frame. In one or more embodiments, the conformal coating can be disposed on at least 90 percent of these exposed surfaces of the electronics module. Further, in one or more embodiments, the exposed surfaces upon which the coating is disposed can include exposed surfaces of an inner side of the frame that defines an inner volume of the electronics module and exposed surfaces of an electronic component that is disposed within this inner volume. The conformal coating can include any suitable thickness, e.g., at least 5 micrometers. In one or more embodiments, the electronics module can include one or more uncoated portions, e.g., at least one of a microphone port of a microphone of the module or a charging contact that is electrically connected to a power source of the module.

Ear-wearable electronic devices such as hearing devices can be disposed on or at least partially within an ear of a wearer. For example, a behind-the-ear ear-wearable electronic device can include a housing that is disposed between a wearer’s ear and skull. The housing can contain an electronic module that includes one or more electronic components such as a receiver (i.e., speaker) and a microphone.

The ear can, however, be a challenging environment for these electronic components. As a result, protecting these components from sweat, cerumen, and other contaminants can be important for longevity of ear-wearable electronic devices. In particular, electronic components can be sensitive to environmental conditions that can lead to shorts and corrosion.

Some currently-available techniques for protecting electronic components include use of point of interest conformal coating and gasketing materials disposed on or within the housing of the device to prevent exposure of electronic components to contaminants. Such techniques can, however, be time consuming and costly. Additionally, because such techniques can be manual, critical points can be missed, and a volume of coating material that is dispensed may be variable, thereby forming a coating that may fail to protect the coated component.

One or more embodiments of ear-wearable electronic devices described herein can provide various advantages over currently-available devices. For example, the electronic device may include a conformal coating disposed on a substantial portion of an electronics module of the device that can protect electronic components and circuitry of the module but also reduce the weight and cost of the device by eliminating or reducing the number of gaskets needed to prevent ingress of contaminants into these components. Further, by disposing the conformal coating on a substantial portion of the electronics module instead of spot applying a coating to one or more components of the module, manufacturing costs can be reduced. In one or more embodiments, the conformal coating can be applied after electronic components of the module have been electrically connected, thereby coating the exposed surfaces of the coatings and their electrical connections.

The conformal coating can include any suitable material. For example, the conformal coating can include parylene, which can provide an effective moisture barrier at smaller thicknesses, e.g., less than 12 micrometers, less than 5 micrometers, etc. This thin coating can infiltrate small gaps between electronic components and between the components and a frame of the module upon which the components are disposed, thereby further preventing ingress of contaminants into the components and circuitry of the module.

In one or more embodiments, the conformal coating can provide various mechanical and/or acoustical benefits to the device. For example, the conformal coating can be configured to reduce a noise floor of the ear-wearable electronic device as compared to a device having an electronics module without the coating by reducing crosstalk and vibrations caused by mechanical movement between the components and the frame of the module. In one or more embodiments, the conformal coating can be configured to dampen vibrations by holding components such as the microphone more firmly in place so that fewer harmonics caused by these vibrations are present in a microphone signal of the device.

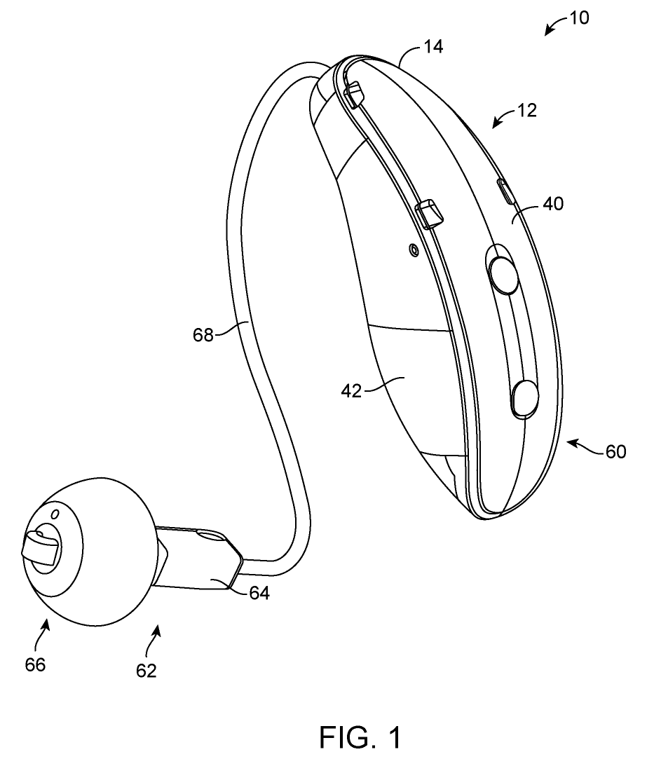

FIGS. 1–5 are various views of one embodiment of an ear-wearable electronic device 10. The device 10 can include any suitable device, e.g., hearing assistance devices, or hearing aids of various types, such as behind-the-ear (BTE), in-the-ear (ITE), in-the-canal (ITC), receiver-in-canal (RIC), or completely-in-the-canal (CIC) type hearing aids. It is understood that BTE type ear-wearable electronic devices can include devices that reside substantially behind the ear or over the ear. Such devices may include hearing aids with receivers associated with the electronics portion of the device or hearing aids of the type having receivers in the ear canal of the user, including but not limited to receiver-in-canal (RIC) or receiver-in-the-ear (RITE) designs. The present subject matter can also be used devices generally, such as cochlear implant type hearing devices and deep insertion devices having a transducer, such as a receiver or microphone, whether custom fitted, standard, open fitted, or occlusive fitted. It is understood that other devices not expressly stated herein may also be used with the present subject matter.

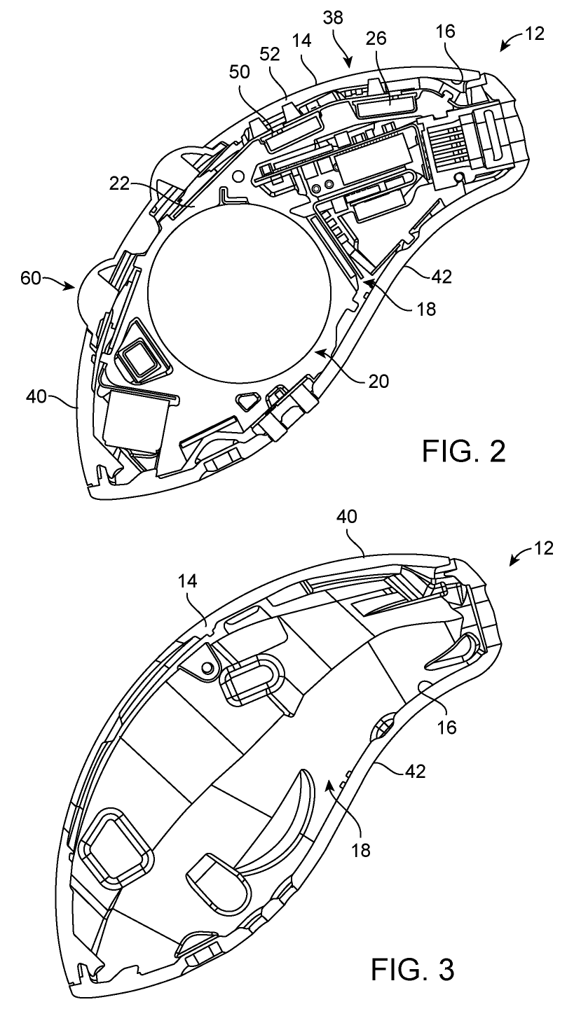

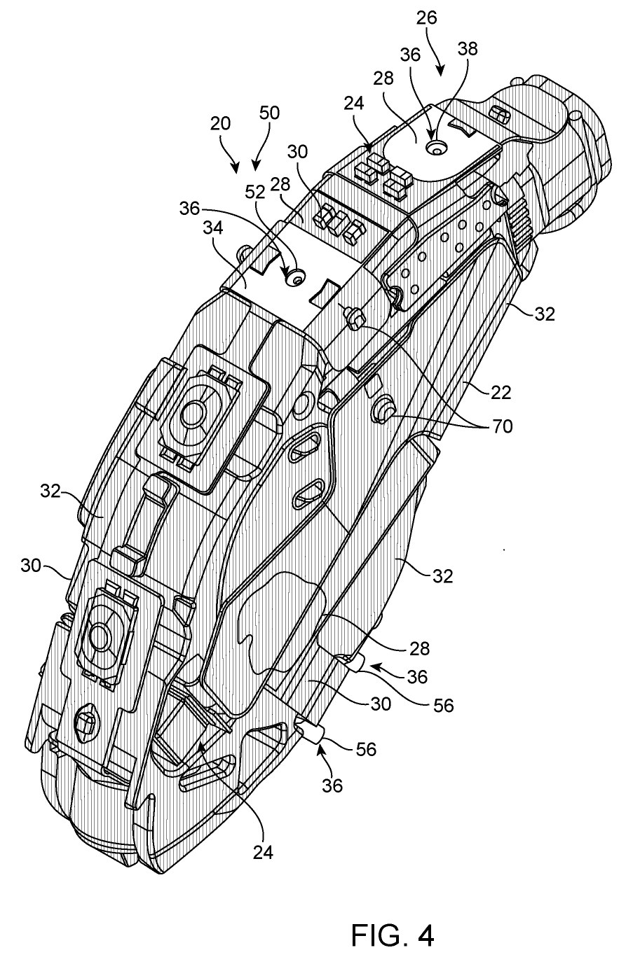

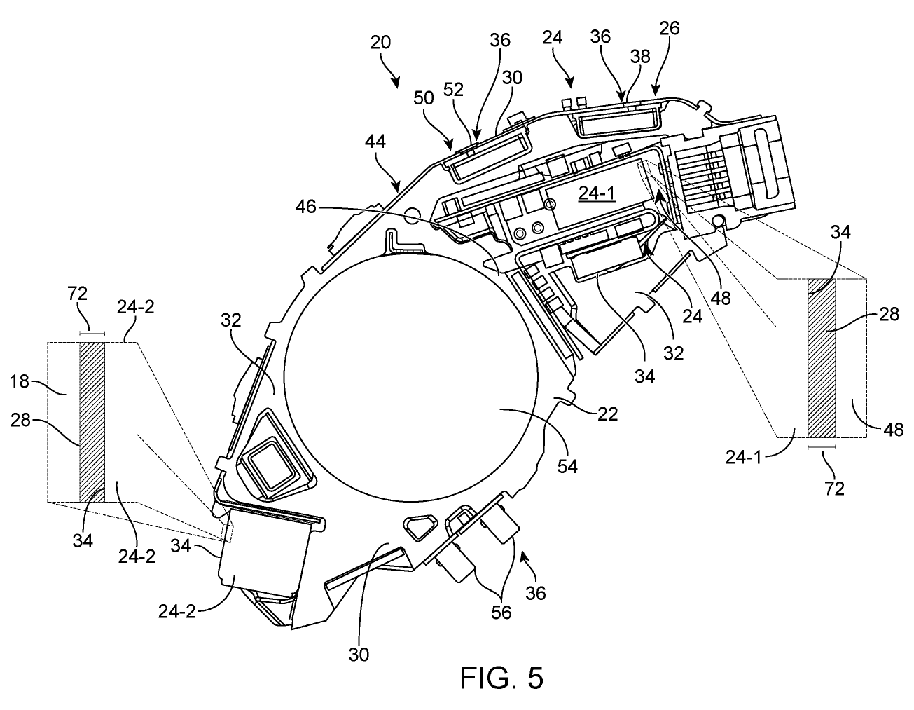

In the illustrated embodiment, the device 10 is a behind-the-ear (BTE) type device and thus includes a housing 12. The device 10 further includes an electronics module 20 disposed at least partially within an interior volume 18 of the housing (FIG. 2). As shown in FIG. 3, which is a schematic cross-section view of the housing 12 with the electronics module 20 removed for explanatory purposes, such housing includes an outer surface 14 and an inner surface 16 that defines the interior volume 18. The electronics module 20 includes a frame 22 and a plurality of electronic components 24 connected to the frame. The electronic components 24 can include any suitable components or circuitry, e.g., a microphone 26. The device 10 further includes a conformal coating 28 (FIGS. 4–5) disposed on exposed surfaces 30 of the electronics module 20. The exposed surfaces 30 of the electronics module 20 include exposed surfaces 32 of the frame 22 and exposed surfaces 34 of each electronic component of the plurality of electronic components 24 connected to the frame. In one or more embodiments, the conformal coating 28 can be disposed on at least 90 percent of these exposed surfaces 30. Further, in one or more embodiments, the conformal coating 28 can be disposed on no greater than 98 percent of the exposed surfaces 30 of the electronics module 20. Further, the module 20 can include one or more uncoated portions 36. Such uncoated portions 36 can include a microphone port 38 of the microphone 26.

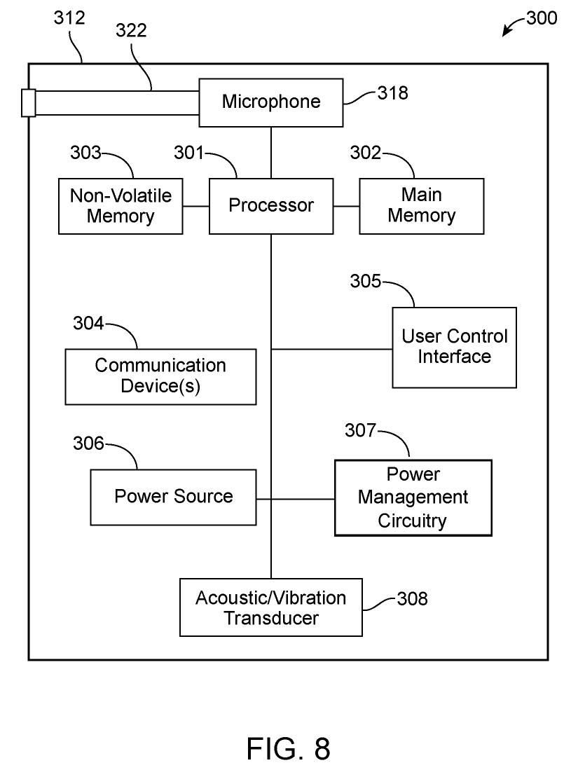

The device 10 can include any suitable electronic components or circuitry, e.g., the electronic components of ear-wearable electronic device 300 of FIG. 8 as is further described herein. The device 10 can also include an earpiece 62 that is coupled to the housing 12 by a cable 68 (FIG. 1). The earpiece 62 can include an earpiece housing 64 and a receiver (e.g., acoustic/vibration transducer 308 of FIG. 8) disposed at least partially within the earpiece housing. The receiver is configured to direct acoustic waves into the wearer’s ear through a receiver path that extends between an outlet 66 disposed at an outer surface of the earpiece housing 64 and an inlet (not shown) disposed within the earpiece housing that is acoustically coupled to the receiver. This configuration is referred to as receiver-in-canal (RIC). Note that the features described herein, while shown implemented in a RIC device, are applicable to other configurations, such as in-the-canal (ITC) types of devices, in which the receiver is integrated into a housing that fits in the ear canal. In such device, the housing (which holds at least one externally-facing microphone) may be hidden in the canal or housing or have a visible part in the outer ear extending from the ear canal.

The ear-wearable electronic device 10 can also include one or more user input devices 60 (FIGS. 1–2). In the illustrated embodiment, the user input devices 60 are disposed on a top shell 40 of the housing 12, but other placements of the user input devices are possible. The user input devices 60 may include buttons, switches, or the like, such as a first button and a second button. The wearer can interact with the user input devices 60 (e.g., by pressing one or more buttons) to, e.g., adjust the volume, change one or more settings, or turn the ear-wearable electronic device 10 on or off.

The housing 12 of the device 10 can take any suitable shape and have any suitable dimensions. In one or more embodiments, the housing 12 is configured to rest against the wearer’s outer ear in a behind-the-ear orientation. The housing 12 can be manufactured using any suitable technique, e.g., injection-molding, 3D printing, etc. Further, the housing 12 can also include any suitable material, e.g., at least one of an inorganic (e.g., metallic, ceramic) or organic (e.g., polymeric) material. In one or more embodiments, the housing 12 can include at least one of silicone, urethane, acrylate, flexible epoxy, or acrylated urethane.

The housing 12 can be a single, integral housing or two or more portions that are connected using any suitable technique. In the illustrated embodiment, the housing 12 includes the top shell 40 and a bottom shell 42. For purposes of this disclosure, the terms “top,” “bottom,” “above,” “below,” “front,” “back,” etc. are not intended to indicate a required orientation of use relative to the ground or other reference point. Generally, these terms are intended to help distinguish locations relative to an arbitrary reference point and may correspond to the orientation in the drawings, but no limitation is intended by the use of these terms.

The top shell 40 can be connected to the bottom shell 42 using any suitable technique, e.g., adhering, snap fitting, press fitting, mechanically fastening, welding, etc. In one or more embodiments, the top shell 40 can be removably connected to the bottom shell 42 using any suitable technique.

The top and bottom shells 40, 42 form the interior volume 18 that is defined by the inner surface 16 of the housing 12 and that, once assembled, holds the electronics module 20. The module 20 can be disposed in any suitable portion of the interior volume 18. In one or more embodiments, the frame 22 of the module 20 can be connected to at least one of the top shell 40 or bottom shell 42. In one or more embodiments, the module 20 can be friction fit within the interior volume 18 of the housing 12 so that the module remains fixed relative to the housing.

The frame 22 can take any suitable shape and have any suitable dimensions. In one or more embodiments, the frame 22 can include an outer side 44 and an inner side 46 that defines an inner volume 48 of the electronics module 20 (FIG. 5). At least one electronic component 24–1 of the plurality of electronic components 24 can be disposed within the inner volume 48 of the module 20. Although depicted as including a single piece or part, in one or more embodiments, the frame 22 can include two or more pieces or parts that are connected together utilizing any suitable technique.

Further, the frame 22 can include any suitable material, e.g., at least one of an inorganic (e.g., metallic, ceramic) material or an organic (e.g., polymeric) material. The frame 22 can be configured to support the electronic components 24. In one or more embodiments, the frame 22 can include a flexible printed circuit board assembly (PCBA). The PCBA can include any suitable substrate, conductive, and insulative layers. It is understood that the flexible PCBA is a laminated, flexible sandwich structure that can include conductive layers, insulating layers, and vias allowing for interconnections between layers. The circuit substrates considered in this disclosure encompass any rigid substrate including FR4, bismaleimide-triazine (BT) epoxy, ceramic, beryllium oxide, or composite epoxy materials (CEM). In addition, flexible substrates considered in this disclosure include polyimide, PEEK, PET, transparent conductive polyester or 1:1 film. Any combination of “flex-rigid” such as FR4 and polyimide also is intended in this disclosure.

The electronics module 20 of the device 10 also includes the plurality of electronic components 24 that are connected to the frame 22. These electronic components 24 can be connected to the frame 22 using any suitable technique, e.g., pins, snap features, clips, friction-fit tabs and slots, wraps, solder, etc. For example, one or more conductive traces or leads can be connected to the frame 22, and one or more of the electronic components can be electrically connected to the conductive traces. Further, for example, one or more of the electronic components 24 can be adhered to the frame 22 utilizing any suitable adhesive. In addition, as shown in FIG. 4, one or more of the electronic components 24 can be connected to the frame 22 by one or more pins or tabs 70 that are connected to the frame and inserted through openings in the electronic components. The pins 70 can be configured to retain the electronic component 24 to the frame. In addition to the components 24 that are connected to the frame 22, one or more additional electronic components can be disposed on or at least partially within the housing 12 and not connected to the frame.

The electronic components 24 can include any suitable components or circuitry, e.g., one or more of the components described herein regarding ear-wearable electronic device 300 of FIG. 8. For example, the components 24 can include the microphone 26 (FIG. 5) that includes the microphone port 38. The microphone 26 can be disposed on or within the housing 12 in any suitable location. Further, the electronics module 20 can include any suitable number of microphones. As shown in FIG. 5, the module 20 includes the microphone 26, which can define a first microphone, and a second microphone 50 connected to the frame 22. The second microphone 50 can include a microphone port 52. The uncoated portion 36 of the electronics module 20 can further include the microphone port 52 of the second microphone 50. In one or more embodiments, the electronic components 24 can further includes at least one of a receiver (e.g., acoustic/vibration transducer 308 of device 300 of FIG. 8) or a controller (e.g., processor 301 of device 300 of FIG. 8).

The first and second microphones 26, 50 can each include any suitable microphone, e.g., a MEMS microphone, an electret condenser microphone, co-joined microphone sets, etc. The microphones 26, 50 can be configured to convert acoustic energy (e.g., acoustic waves) that enter the microphone through its respective port 38, 52 into one or more electric signals that are directed to a controller or processor (e.g., processor 301 of ear-wearable electronic device 300 of FIG. 8) disposed within the housing 12 or remotely from the housing by a wired or wireless connection.

In one or more embodiments, the plurality of electronic components 24 can further include a power source 54. The power source 54 can include any suitable energy source that can provide electrical energy to one or more of the electronic components 24 of the electronics module 20 and/or one or more additional electronic components of the device 10. In one or more embodiments, the power source 54 includes a rechargeable battery. The power source 54 can be electrically connected to one or more charging contacts 56 (FIG. 5) that can be utilized to provide electrical energy to the power source 54 via a charger that is external to the device 10. The device 10 can include any suitable number of charging contacts 56 disposed in any suitable portion or portions of the housing 12. As is further described herein, the uncoated portion or portions 36 of the electronics module 20 can include the charging contacts 56.

As mentioned herein, the conformal coating 28 can be disposed on one or more exposed surfaces of the module 20. The conformal coating 28 can include any suitable material, e.g., at least one of an inorganic (e.g., metallic, ceramic) or organic (e.g., polymeric) material. In one or more embodiments, the conformal coating 28 can include a polymer. For example, the conformal coating can include parylene. Any suitable types of parylene can be utilized, e.g., at least one of C, N, F, or D dimers of parylene.

Further, the conformal coating 28 can be disposed on any suitable portion or portions of exposed surfaces 30 of the electronics module 20. As used herein, the term “exposed surface” means a surface of the frame 22 or electronic component 24 that is not covered or blocked but instead is open to an environment surrounding the electronics module 20 (e.g., air and other materials within the interior volume of the housing) prior to disposing the conformal coating 28 thereon. For example, a surface of an electronic component 24 that is sealed or connected to the frame 22 is not considered to be an exposed surface 30 as there is no space between such surface of the component and the frame. In general, exposed surfaces include any surface that can be exposed to contaminants or the external environment of the electronics module 20. In one or more embodiments, the conformal coating 28 can be disposed on at least 90 percent of the exposed surfaces 30 of the electronics module 20. Further, in one or more embodiments, the conformal coating 28 can be disposed on no greater than 98 percent of the exposed surfaces 30 of the electronics module 20.

Any suitable portion or portions of the electronics module 20 can remain uncoated, i.e., the conformal coating 28 is not disposed on such portion or portions to provide one or more uncoated portions. In one or more embodiments, the uncoated portion 36 of the module 20 can include at least the microphone port 38 of the first microphone 26. Although not wishing to be bound by any particular theory, leaving the microphone port 38 uncoated can allow more acoustic energy from sound waves that are directed to the port to be detected by the microphone 26. In one or more embodiments, at least one of the microphone port 38 of the first microphone 26 or the microphone port 52 of the second microphone 50 can be uncoated to provide uncoated portions 36 of the module 20. Further, in one or more embodiments, one or more of the charging contacts 56 can be uncoated to provide uncoated portion 36.

The uncoated portion 36 of the electronics module 20 can be formed using any suitable technique. In one or more embodiments, a mask can be disposed on one or more portions of the electronics module 20 prior to disposing the conformal coating 28 on the module to define the uncoated portion or portions 36. Any suitable mask can be utilized, e.g., tape, molded material, dielectric coating, polymeric maskant, removable protective material, etc. The uncoated portions 36 of the module 20 can be contiguous or separated by one or more portions of the conformal coating 28.

The coating 28 can be disposed on exposed surfaces 30 of the electronics module 20 using any suitable technique. In one or more embodiments, the coating 28 can be disposed on the exposed surfaces 30 utilizing at least one of vapor deposition, chemical vapor deposition, physical vapor deposition, plasma vapor deposition, dip coating, spraying, electrospraying, sputtering, etc.

The coating 28 can have any suitable thickness. For example, as shown in FIG. 5, the coating 28 disposed on an exposed surface 34 of electronic device 24–1 and 24–2 can have any suitable thickness 72. The coating 28 is not shown in exposed surfaces of the frame 22 as the figure is a cross-section view of the electronics module 20. In one or more embodiments, the coating 28 can have a uniform thickness over the exposed surfaces 30 of the electronics module 20. In one or more embodiments, the coating 28 can have a thickness that varies over the exposed surfaces 30 of the module 20. Further, the coating 28 can have any suitable average thickness. In one or more embodiments, the coating 28 can have an average thickness of at least 5 micrometers. In one or more embodiments, the coating 28 can have an average thickness of at least 10 micrometers, 12 micrometers, or 15 micrometers. In one or more embodiments, the coating 28 can have an average thickness of no greater than 30, 40, 50, or 90 micrometers.

As mentioned herein, in one or more embodiments, the frame 22 can include the inner side 46 that can define the inner volume 48 of the electronics module 20. The coating 28 can be disposed on exposed surfaces 32 of the inner side 46 of the frame 22 and exposed surfaces 34 the at least one electronic component 24–1 disposed within the inner volume 48. In such embodiments, the coating 28 can have any suitable average thickness within the inner volume 48. In one or more embodiments, the coating 28 can have an average thickness of at least 5 micrometers within the inner volume 48 of the frame 22 and no greater than 30 micrometers.

The conformal coating 28 can be configured to provide various mechanical and/or acoustical properties to the electronics module 20 and the device 10. In one or more embodiments, the conformal coating 28 can improve perception of sound quality that the device 10 provides to the wearer over devices that do not include such coating. While not wishing to be found by any particular theory, the conformal coating 28 may provide this improved sound quality by at least one of reducing circuit noise, crosstalk, or vibration of components. In one or more embodiments, the conformal coating 28 can be configured to reduce Equivalent Input Noise (EIN) of the device 10 compared to an EIN of the device including the electronics module without the coating. The EIN can be measured utilizing any suitable technique.

Further, the conformal coating 28 can be configured to decrease a noise floor of the device 10 compared to a noise floor of the device including the electronics module without the coating.. As used herein, the term “noise floor” means an inherent electrical or acoustic noise produced by the device’s microphone, amplifier, or processing circuitry, measured in the absence of an external input signal. The noise floor can be measured utilizing any suitable technique.

The conformal coating 28 can also be configured to reduce a Total Harmonic Distortion plus Noise (THDN) of the device 10 compared to a THDN of the device including the electronics module without the coating.. Any suitable technique can be utilized to measure THDN.

In addition, the conformal coating 28 can be configured to reduce mechanical vibrations of the device 10 compared to mechanical vibrations of the device including the electronics module without the coating. Any suitable technique can be utilized to measure mechanical vibrations of the module 20.

The conformal coating 28 can provide any suitable protection to the electronics module 20. In one or more embodiments, the conformal coating 28 can be configured to hermetically seal the electronics module 20 except for the uncoated portions 36 of the module, e.g., the microphone port 38 of the microphone 26. Hermeticity of the coating 28 can be measured using any suitable technique, e.g., ASTM B117-19, entitled STANDARD PRACTICE FOR OPERATING SALT SPRAY (FOG) APPARATUS. In one or more embodiments, the coating 28 can be configured to increase a performance of the electronics module 20 in the salt fog test by at least 900 percent. To generate failures, exemplary electronics modules 20 were tested. Failure of an electronics modules 20 was defined as a failure of the module to turn on, respond to switch presses, have functioning radio and Wi-Fi, and exhibit normal charging and discharging of the power source 54. Microphone response was not measured as the microphone port 38 of the microphone 26 was not protected against incursion of the salt fog.

The conformal coating 28 can exhibit any suitable permeability. In one or more embodiments, the coating 28 can have a permeability of no greater than 3.0 (cc*mm)/(m^2*day*atm). Any suitable technique can be utilized to measure the permeability of the coating 28.

Further, the conformal coating 28 can include any suitable number of layers, e.g., one, two, three, four, or more layers. In one or more embodiments, each layer of the conformal coating 28 can include the same material. In one or more embodiments, at least one layer of the conformal coating 28 can include a material that is different from material from one or more additional layers of the conformal coating. In one or more embodiments, the conformal coating 28 can include alternating layers of a first polymer and a second polymer.

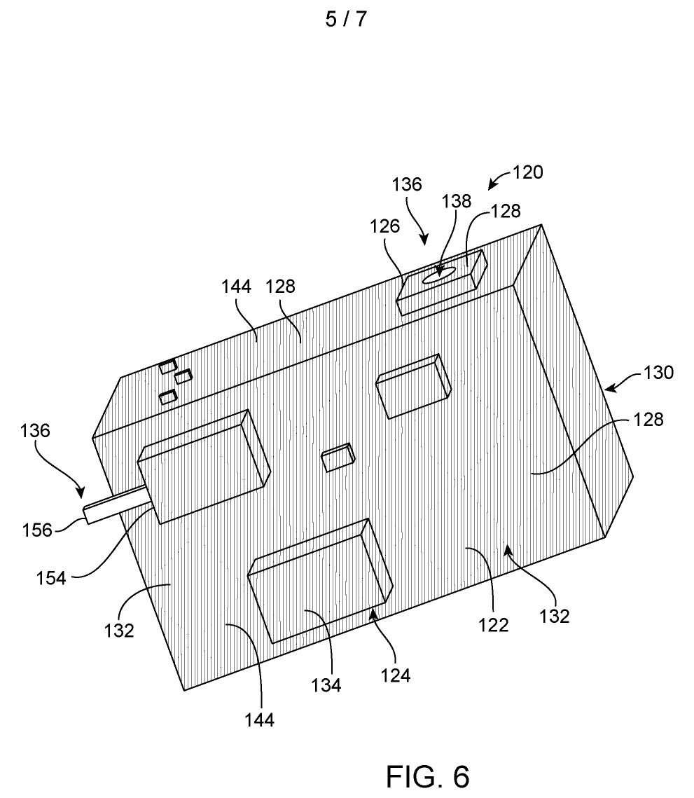

As mentioned herein, the frame 22 of the electronics module 20 can take any suitable shape. For example, FIG. 6 is a schematic plan view of another embodiment of an electronics module 120. All design considerations and possibilities described herein regarding electronics module 20 of FIGS. 2–5 apply equally to electronics module 120 of FIG. 6 unless stated otherwise. The module 120 can be utilized with any suitable ear-wearable electronic device, e.g., device 10 of FIGS. 1–5.

The electronics module 120 includes a frame 122 and a plurality of electronic components 124 connected to the frame. The module 120 also includes a conformal coating 128 disposed on at least a portion of exposed surfaces 130 of the electronics module, i.e., exposed surfaces 132 of the frame 122 and exposed surfaces 134 of the electronic components 124. Further, the electronics module 120 also includes one or more uncoated portions 136, including a microphone port 138 of microphone 126 and charging contact 156 that can be electrically connected to power source 154.

As shown in FIG. 6, the frame 122 takes a continuous prismatic shape. Unlike the frame 22 of FIGS. 2–5, the frame 122 does not include an inner side that defines an inner volume. Instead, the frame 122 has an outer side or surface 144 upon which the electronic components 124 are disposed. Although depicted as a single part or piece, the frame 122 can include two or more pieces that are connected together utilizing any suitable technique.

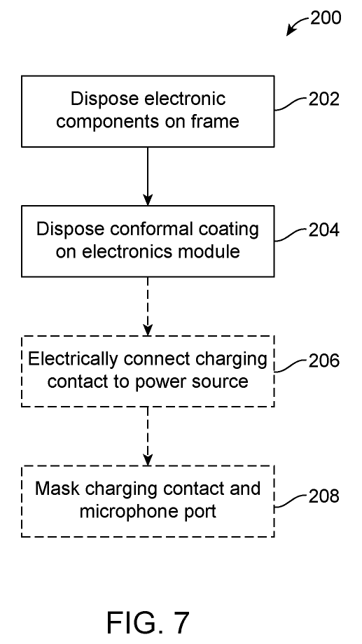

Any suitable technique can be utilized to manufacture the various embodiments of ear-wearable electronic devices described herein. For example, FIG. 7 is a flowchart of one technique 200 of manufacturing the ear-wearable electronic device 10 of FIGS. 1–5. Although described regarding ear-wearable electronic device 10 of FIGS. 1–5, the technique 200 can be utilized to manufacture any suitable ear-wearable electronic device. The technique 200 includes forming the electronics module 20.

At 202, the electronics module 20 can be formed by disposing the plurality of electronic components 24 on the frame 22 using any suitable technique, e.g., manual assembly, pick and place, robotic assembly, printing, etc. The conformal coating 28 is disposed on the electronics module 20 at 204 using any suitable technique, e.g., vapor deposition. In one or more embodiments, the coating 28 is disposed on at least 90 percent and no greater than 98 percent of exposed surfaces 30 of the electronics module 20. In one or more embodiments, the coating 28 can be disposed so that uncoated portions 36 of the electronics module 20 includes at least one of the microphone port 38 of the first microphone 26, the microphone port 52 of the second microphone 50, or the one or more charging contacts 56. In one or more embodiments, the coating 28 can be disposed on exposed surfaces 32 of the inner side 46 of the frame 22 and exposed surfaces 34 of the at least one electronic component 24–1 disposed within the inner volume 48 of the electronics module 20 using any suitable technique, e.g., the same techniques described herein regarding disposing the coating on the outer side 44 of the frame 22. In such embodiment, the coating 28 can include an average thickness within the inner volume 48 of at least 10 micrometers. The coating 28 can hermetically seal the electronics module 20.

At 206, one or more charging contacts 56 can optionally be connected to the power source 54 of the plurality of electronic components 24 using any suitable technique. In such embodiment, the uncoated portions 36 of the electronics module 20 can include the one or more charging contacts 56. In one or more embodiments, the power source 54 can be connected to the one or more charging contacts 56 when the electronics module 20 is formed at 202. In one or more embodiments, the power source 54 can be connected to the one or more charging contacts 56 after the coating 28 is disposed on the electronics module 20 at 204. Further, at 208, any suitable portion or portions of the electronic components 24 can optionally be masked using any suitable technique prior to disposing the coating 28 on the electronics module 20 at 204. For example, at least one of the microphone port 38 of the first microphone 26, the microphone port 52 of the second microphone 50, or the charging contacts 56 (if present) can be masked prior to disposing the conformal coating 28 on the electronics module 20. One or more portions of the mask can be removed from the electronics module 20 using any suitable technique after the conformal coating 28 is disposed on the electronics module 20 at 204.

The various embodiments of ear-wearable devices described herein can include any suitable electronic components or circuitry. For example, FIG. 8 is a block diagram that illustrates one embodiment of an ear-wearable electronic device 300 in accordance with any of the embodiments disclosed herein. The device 300 includes a housing 312 configured to be worn in, on, or about an ear of a wearer. The device 300 shown in FIG. 8 can represent a single device configured for monaural or single-ear operation or one of a pair of devices configured for binaural or dual-ear operation. Various components are situated or supported within or on the housing 312. The housing 312 can be configured for deployment on a wearer’s ear (e.g., a behind-the-ear device housing), within an ear canal of the wearer’s ear (e.g., an in-the-ear, in-the-canal, invisible-in-canal, or completely-in-the-canal device housing) or both on and in a wearer’s ear (e.g., a receiver-in-canal or receiver-in-the-ear device housing).

The device 300 includes a processor 301 operatively coupled to a main memory 302 and a non-volatile memory 303. The processor 301 can be implemented as one or more of a multi-core processor, a digital signal processor (DSP), a microprocessor, a programmable controller, a general-purpose computer, a special-purpose computer, a hardware controller, a software controller, a combined hardware and software device, such as a programmable logic controller, and a programmable logic device (e.g., FPGA, ASIC). The processor 301 can include or be operatively coupled to main memory 302, such as RAM (e.g., DRAM, SRAM). The processor 301 can include or be operatively coupled to non-volatile (persistent) memory 303, such as ROM, EPROM, EEPROM or flash memory.

The device 300 includes an audio processing facility operably coupled to, or incorporating, the processor 301. The audio processing facility includes audio signal processing circuitry (e.g., analog front-end, analog-to-digital converter, digital-to-analog converter, DSP, and various analog and digital filters), a microphone arrangement 318, and an acoustic/vibration transducer 308 (e.g., loudspeaker, receiver, bone conduction transducer, motor actuator). The acoustic transducer 308 produces amplified sound inside of the ear canal. The microphone arrangement 318 can include one or more discrete microphones or a microphone array(s) (e.g., configured for microphone array beamforming). Each of the microphones of the microphone arrangement 318 can be situated at different locations of the housing 312. It is understood that the term microphone used herein can refer to a single microphone or multiple microphones unless specified otherwise. The microphone 318 is operatively coupled to the processor 301 and is configured to direct a microphone signal to the processor, which in turn directs a receiver signal to the transducer 308 that is based at least in part on the microphone signal.

At least one of the microphones 318 may be configured as a reference microphone producing a reference signal in response to external sound outside an ear canal of a user. Generally, at least one the reference microphones 318 (also referred to as an externally facing microphones) is acoustically coupled to ambient air outside the housing 312 via an acoustic path 322 and an opening defined by the housing. The acoustic path 322 allows air to pass between two parts of the housing 312 or may be formed within one part of the housing.

The device 300 may also include a user control interface 305 operatively coupled to the processor 301. The user control interface 305 is configured to receive an input from the wearer of the device 300. The input from the wearer can be any type of user input, such as a touch input, a gesture input, or a voice input. The user control interface 305 may be configured to receive an input from the wearer of the device 300.

The device 300 can include one or more communication devices 304. For example, the one or more communication devices 304 can include one or more radios coupled to one or more antenna arrangements that conform to an IEEE 802.13 (e.g., Wi-Fi®) or Bluetooth® (e.g., BLE, Bluetooth® 4.2, 5.0, 5.1, 5.2 or later) specification, for example. In addition, or alternatively, the device 300 can include a near-field magnetic induction (NFMI) sensor (e.g., an NFMI transceiver coupled to a magnetic antenna) for effecting short-range communications (e.g., ear-to-ear communications, ear-to-kiosk communications). The communication device 304 may also include wired communications, e.g., universal serial bus (USB) and the like.

The device 300 also includes a power source 306, which can be a conventional battery, a rechargeable battery (e.g., a lithium-ion battery), or a power source including a supercapacitor. In the embodiment shown in FIG. 8, the power source 306 can be operably coupled to optional power management circuitry 307 for supplying power to various components of the device 300. In embodiments of the device 300 where the power source 306 is a rechargeable power source, the power management circuitry 307 can include charging circuity configured to charge the power source using any suitable technique. In one or more embodiments, the power management circuitry 307 can be electrically coupled to charging contacts on the housing 312 that are configured to electrically couple to corresponding charging contacts of a charging unit when the device 300 is placed in the charging unit.

Embodiments of the disclosure are defined in the claims; however, herein there is provided a non-exhaustive listing of non-limiting Clauses. Any one or more of the features of these Clauses may be combined with any one or more features of another example, embodiment, or aspect described herein.

Clause 1. An ear-wearable electronic device comprising: a housing comprising an outer surface and an inner surface that defines an interior volume; an electronics module disposed at least partially within the interior volume of the housing, wherein the electronics module comprises: a frame; and a plurality of electronic components connected to the frame and comprising a microphone; and a conformal coating disposed on at least 90 percent and no greater than 98 percent of exposed surfaces of the electronics module, wherein exposed surfaces of the electronics module comprise exposed surfaces of the frame and each electronic component of the plurality of electronic components connected to the frame, wherein an uncoated portion of the electronics module comprises a microphone port of the microphone.

Clause 2. The device of Clause 1, wherein the conformal coating comprises an average thickness of at least 5 micrometers.

Clause 3. The device of any one of Clauses 1–2, wherein the frame comprises an outer side and an inner side that defines an inner volume of the electronics module, wherein at least one electronic component of the plurality of electronic components is disposed within the inner volume of the electronics module.

Clause 4. The device of Clause 3, wherein the coating disposed on exposed surfaces of the inner side of the frame and the at least one electronic component disposed within the inner volume of the electronics module comprises an average thickness of at least 5 micrometers.

Clause 5. The device of any one of Clauses 1–4, wherein the conformal coating comprises parylene.

Clause 6. The device of any one of Clauses 1–5, wherein the plurality of electronic components further comprises a power source electrically connected to a charging contact of the device, wherein the uncoated portion further comprises the charging contact.

Clause 7. The device of any one of Clauses 1–6, wherein the conformal coating is configured to reduce Equivalent Input Noise (EIN) of the device compared to an EIN of the device comprising the electronics module without the coating.

Clause 8. The device of any one of Clauses 1–7, further comprising a faceplate connected to the housing to form an enclosure, wherein the electronics module is disposed within the enclosure.

Clause 9. The device of any one of Clauses 1–8, wherein the conformal coating is configured to decrease a noise floor of the device compared to a noise floor of the device comprising the electronics module without the coating.

Clause 10. The device of any one of Clauses 1–9, wherein the conformal coating is configured to reduce a Total Harmonic Distortion plus Noise (THDN) of the device compared to a THDN of the device comprising the electronics module without the coating.

Clause 11. The device of any one of Clauses 1–10, wherein the coating is configured to reduce mechanical vibrations of the device compared to mechanical vibrations of the device without the coating.

Clause 12. The device of any one of Clauses 1–11, further comprising an earpiece connected to the housing by a cable.

Clause 13. The device of any one of Clauses 1–12, wherein the frame comprises a flexible PCBA.

Clause 14. The device of any one of Clauses 1–13, wherein the plurality of electronic components further comprises at least one of a receiver or a controller.

Clause 15. The device of any one of Clauses 1–14, wherein the coating is configured to increase a performance of the electronics module in a salt fog test by at least 900 percent.

Clause 16 An electronics module for an ear-wearable electronic device, the electronics module comprising: a housing comprising an outer surface and an inner surface that defines an interior volume; an electronics module disposed at least partially within the interior volume of the housing, wherein the electronics module comprises: a frame; and a plurality of electronic components connected to the frame and comprising a microphone; and a conformal coating disposed on at least 90 percent of exposed surfaces of the plurality of electronic components, wherein the coating is configured to reduce a noise floor of the device compared to a noise floor of the device comprising the electronics module without the coating.

Clause 17. The module of Clause 16, wherein the conformal coating comprises an average thickness of at least 5 micrometers.

Clause 18. The module of any one of Clauses 16–17, wherein the frame comprises an outer side and an inner side that defines an inner volume of the electronics module, wherein at least one electronic component of the plurality of electronic components is disposed within the inner volume of the electronics module.

Clause 19. The module of Clause 18, wherein the coating disposed on exposed surfaces of the inner side of the frame and the at least one electronic component disposed within the inner volume of the electronics module comprises an average thickness of at least 5 micrometers.

Clause 20. The module of any one of Clauses 16–19, wherein the plurality of electronic components further comprises a power source electrically connected to a charging contact of the device, wherein an uncoated portion of the electronics module comprises the charging contact and a microphone port of the microphone.

Clause 21. The module of any one of Clauses 16–20, wherein the coating comprises parylene.

Clause 22. The module of any one of Clauses 16–21, wherein the coating comprises an average thickness of at least 5 micrometers.

Clause 23. The module of any one of Clauses 16–22, wherein the coating is configured to reduce Equivalent Input Noise (EIN) of the device compared to an EIN of the device comprising the electronics module without the coating.

Clause 24. The module of any one of Clauses 16–23, wherein the conformal coating is configured to hermetically seal the electronics module.

Clause 25. The module of any one of Clauses 16–24, wherein the coating has a permeability of no greater than 3.0 (cc*mm)/(m^2*day*atm).

Clause 26. The module of any one of Clauses 16–25, wherein the coating is configured to reduce mechanical vibrations of the device compared to mechanical vibrations of the device comprising the electronics module without the coating.

Clause 27. The module of any one of Clauses 16–26, wherein the frame comprises a flexible PCBA.

Clause 28. The module of any one of Clauses 16–27, wherein the plurality of electronic components further comprises at least one of a receiver or a controller.

Clause 29. A method of forming an ear-wearable electronic device comprising forming an electronics module, wherein forming the electronics module comprises: disposing a plurality of electronic components on a frame, wherein the plurality of electronic components comprises a microphone; and disposing a conformal coating on the electronics module so that the coating is disposed on at least 90 percent and no greater than 98 percent of exposed surfaces of the electronics module, wherein the exposed surfaces of the electronics module comprise exposed surfaces of the frame and each electronic component of the plurality of electronic components connected to the frame, wherein an uncoated portion of the electronics module comprises a microphone port of the microphone.

Clause 30. The method of Clause 29, further comprising electrically connecting a charging contact to a power source of the plurality of electronic components, wherein the uncoated portion further comprises the charging contact.

Clause 31. The method of Clause 30, further comprising masking the charging contact and the microphone port prior to disposing the conformal coating on the electronics module.

Clause 32. The method of any one of Clauses 29–31, wherein the conformal coating comprises parylene.

Clause 33. The method of any one of Clauses 29–32, wherein the coating comprises an average thickness of at least 10 micrometers.

Clause 34. The method of Clause 33, wherein the frame comprises an outer side and an inner side that defines an inner volume of the electronics module, wherein disposing the conformal coating comprises disposing the coating on exposed surfaces of the inner side of the frame and at least one electronic component disposed within the inner volume of the electronics module so that the coating comprises an average thickness within the inner volume of at least 10 micrometers.

Clause 35. The method of any one of Clauses 29–34, wherein disposing the coating comprises hermetically sealing the electronics module with the coating.

Clause 36. The method of any one of Clauses 29–35, wherein disposing the coating comprises vapor depositing the conformal coating on the electronics module.

Clause 37. The method of Clause 36, wherein disposing the coating comprises chemical vapor depositing the conformal coating on the electronics module.

Clause 38. The method of any one of Clauses 29–37, wherein the conformal coating is configured to reduce Equivalent Input Noise (EIN) of the device compared to an EIN of the device comprising the electronics module without the coating.

Clause 39. The method of Clause 38, further comprising connecting a faceplate to a housing to define an enclosure, wherein the electronics module is disposed within the enclosure.

Clause 40. The method of any one of Clauses 29–39, wherein the conformal coating is configured to decrease a noise floor of the device compared to a noise floor of the device comprising the electronics device without the coating.

Clause 41. The method of any one of Clauses 29–40, wherein the coating is configured to reduce a Total Harmonic Distortion plus Noise (THDN) of the device compared to a THDN of the device comprising the electronics module without the coating.

Clause 42. The method of any one of Clauses 29–41, wherein the conformal coating is configured to reduce mechanical vibrations of the device compared to mechanical vibrations of the device without the coating.

Clause 43. The method of any one of Clauses 29–42, wherein the frame comprises a flexible PCBA.

Clause 44. The method of any one of Clauses 29–43, wherein the plurality of electronic components further comprises at least one of a receiver or a controller.

All references and publications cited herein are expressly incorporated herein by reference in their entirety into this disclosure, except to the extent they may directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

What is claimed is:

1. An ear-wearable electronic device comprising:
a housing comprising an outer surface and an inner surface that defines an interior volume;
an electronics module disposed at least partially within the interior volume of the housing, wherein the electronics module comprises:
a frame; and
a plurality of electronic components connected to the frame and comprising a microphone; and
a conformal coating disposed on at least 90 percent and no greater than 98 percent of exposed surfaces of the electronics module, wherein exposed surfaces of the electronics module comprise exposed surfaces of the frame and each electronic component of the plurality of electronic components connected to the frame, wherein an uncoated portion of the electronics module comprises a microphone port of the microphone.

2. The device of claim 1, wherein the conformal coating comprises an average thickness of at least 5 micrometers.

3. The device of claim 1, wherein the frame comprises an outer side and an inner side that defines an inner volume of the electronics module, wherein at least one electronic component of the plurality of electronic components is disposed within the inner volume of the electronics module.

4. The device of claim 3, wherein the coating disposed on exposed surfaces of the inner side of the frame and the at least one electronic component disposed within the inner volume of the electronics module comprises an average thickness of at least 5 micrometers.

5. The device of claim 1, wherein the conformal coating comprises parylene.

6. The device of claim 1, wherein the plurality of electronic components further comprises a power source electrically connected to a charging contact of the device, wherein the uncoated portion further comprises the charging contact.

7. The device of claim 1, wherein the conformal coating is configured to decrease a noise floor of the device compared to a noise floor of the device comprising the electronics module without the coating.

8. The device of claim 1, wherein the coating is configured to reduce mechanical vibrations of the device compared to mechanical vibrations of the device without the coating.

9. An electronics module for an ear-wearable electronic device, the electronics module comprising:
a housing comprising an outer surface and an inner surface that defines an interior volume;
an electronics module disposed at least partially within the interior volume of the housing, wherein the electronics module comprises:
a frame; and
a plurality of electronic components connected to the frame and comprising a microphone; and
a conformal coating disposed on at least 90 percent of exposed surfaces of the plurality of electronic components, wherein the coating is configured to reduce a noise floor of the device compared to a noise floor of the device comprising the electronics module without the coating.

10. The module of claim 9, wherein the conformal coating comprises an average thickness of at least 5 micrometers.

11. The module of claim 9, wherein the frame comprises an outer side and an inner side that defines an inner volume of the electronics module, wherein at least one electronic component of the plurality of electronic components is disposed within the inner volume of the electronics module.

12. The module of claim 11, wherein the coating disposed on exposed surfaces of the inner side of the frame and the at least one electronic component disposed within the inner volume of the electronics module comprises an average thickness of at least 5 micrometers.

13. The module of claim 9, wherein the coating comprises parylene.

14. The module of claim 9, wherein the coating comprises an average thickness of at least 5 micrometers.

15. The module of claim 9, wherein the coating is configured to reduce Equivalent Input Noise (EIN) of the device compared to an EIN of the device comprising the electronics module without the coating.

16. The module of claim 9, wherein the coating has a permeability of no greater than 3.0 (cc*mm)/(m^2*day*atm).

17. The module of claim 9, wherein the frame comprises a flexible PCBA.

18. A method of forming an ear-wearable electronic device comprising forming an electronics module, wherein forming the electronics module comprises:
disposing a plurality of electronic components on a frame, wherein the plurality of electronic components comprises a microphone; and
disposing a conformal coating on the electronics module so that the coating is disposed on at least 90 percent and no greater than 98 percent of exposed surfaces of the electronics module, wherein the exposed surfaces of the electronics module comprise exposed surfaces of the frame and each electronic component of the plurality of electronic components connected to the frame, wherein an uncoated portion of the electronics module comprises a microphone port of the microphone.

19. The method of claim 18, further comprising electrically connecting a charging contact to a power source of the plurality of electronic components, wherein the uncoated portion further comprises the charging contact.

20. The method of claim 18, wherein disposing the coating comprises vapor depositing the conformal coating on the electronics module.
